(19) United States
(12) Patent Application Publication
(10) Pub. No.: US 2024/0359197 A1
(43) Pub. Date: Oct. 31, 2024

(54) SPRINKLING CAN

(71) Applicant: Ningbo Feifan Plastic Industry Co., Ltd, Yuyao (CN)

(72) Inventors: Zheng WANG, Yuyao (CN); Jianli YANG, Yuyao (CN)

(73) Assignee: Ningbo Feifan Plastic Industry Co., Ltd, Yuyao (CN)

(21) Appl. No.: 18/646,537

(22) Filed: Apr. 25, 2024

(30) Foreign Application Priority Data
Apr. 26, 2023 (CN) 202320973974 .2

(51) Int. Cl. B05B 11/10

(52) U.S. Cl. CPC B05B 11/1052; B05B 11/10

(57) ABSTRACT

The present invention provides a sprinkling can. The sprinkling can includes a spray head, a trigger, a pump body, a suction assembly, a housing, and a bottle body. The spray head and the trigger are fixed on an outer side of the pump body, the pump body is provided with a water inlet and outlet facility and a ventilation facility, the top of the pump body is provided with a pump cavity, an elastic device is disposed in the pump cavity, the bottom of the pump body is clamped with the top of the suction assembly, the suction assembly is composed of a connection sleeve I, a suction pipe, and a booster pump, the connection sleeve I is provided with a suction pipe column, an air inlet column, and a booster pump base. The glass ball is convenient in installation, stable in structure, and good in sealing property.

### CROSS-REFERENCE TO RELATED APPLICATIONS

The application claims priority to Chinese patent application No. 202320973974.2, filed on Apr. 26, 2023, the entire contents of which are incorporated herein by reference.

### TECHNICAL FIELD

The present invention relates to a sprinkling can.

### BACKGROUND

A sprinkling can is an appliance that turns liquid into mist by means of a suction effect and evenly sprays the mist onto other objects. Currently, a sprinkling can on the market is mainly composed of a spray head, a trigger, a pump body, and a bottle body. In order to make pressure of sprayed mist greater, a booster assembly is generally disposed on the pump body. When the trigger is pulled and then released, a suction pipe at the bottom of the pump body is in communication with an inner cavity of the pump body, and liquid in the bottle body enters the inner cavity of the pump body through the suction pipe, then enters the booster assembly from the inner cavity of the pump body to be stored, and presses a piston and a spring in the booster assembly downwards to store energy. When the trigger is pulled and then released again, the liquid in the inner cavity of the pump body and the booster assembly is sprayed out together through the spray head. This type of sprinkling can has two problems as follows: 1. the booster assembly and the pump body are integrally formed and cannot be separated, and manufacturing costs are relatively high, so that for a user without requirements on injection pressure, a boosting function of the sprinkling can is superfluous; 2. the suction pipe and the inner cavity of the pump body are separated and sealed through a sealing gasket, and during assembly and use, the sealing gasket is prone to deflection, causing that the sealing gasket cannot completely seal a joint between the suction pipe and the inner cavity of the pump body, resulting in leakage.

### SUMMARY

In view of defects present in an existing sprinkling can, a technical problem to be resolved by the present invention is to provide a sprinkling can with a detachable and installable booster pump and a better sealing property.

To achieve the above purpose, according to an aspect of the present invention, the present invention is implemented through the following technical measures: a sprinkling can includes: a spray head, a trigger, a pump body, a suction assembly, a housing, and a bottle body. The spray head and the trigger are fixed on an outer side of the pump body, the pump body is provided with a water inlet and outlet facility and a ventilation facility, the top of the pump body is provided with a pump cavity, an elastic device is disposed in the pump cavity, the bottom of the pump body is clamped with the top of the suction assembly, the suction assembly is composed of a connection sleeve I, a suction pipe, and a booster pump, the connection sleeve I is provided with a suction pipe column, an air inlet column, and a booster pump base, the air inlet column and the suction pipe column are internally hollow, a glass ball is disposed in the suction pipe column, the suction pipe is inserted into the bottom of the suction pipe column, the booster pump base is provided with a water passing hole, the bottom of the booster pump base is clamped with the top of the booster pump, the connection sleeve I can be replaced with a connection sleeve II, and the connection sleeve II differs from the connection sleeve I in that the booster pump base has no water passing hole.

Further, a spray head base and a trigger base are disposed on two sides of the pump cavity, the spray head and the trigger are fixed on the spray head base and the trigger base respectively, a piston and a spring are disposed in the pump cavity, the top of the piston abuts against the trigger, and the bottom of the piston abuts against the spring.

Further, a water outlet channel is disposed in the spray head base, the bottom of the pump cavity is provided with a water inlet hole and a water outlet hole, outer sides of the water outlet hole and the water outlet channel extend downwards to form a booster column, the water outlet hole communicates with the water outlet channel of the spray head base, the water inlet hole extends downwards to form a water inlet column, a side wall of the pump cavity is provided with an air outlet hole, an air inlet channel is disposed below an outer side of the air outlet hole, the air inlet channel extends downwards to form an air outlet column, the top of the booster pump base is in inserted connection with the booster column, the water inlet column is in inserted connection with the suction pipe column, and the air inlet column is in inserted connection with the air outlet column.

Further, a clamping groove I is disposed on a side wall of the pump body, a clamping block I is disposed on a side wall of the connection sleeve I, and the suction assembly is fixed in the pump body through matching between the clamping block I and the clamping groove I.

Further, a clamping groove II is disposed on a side wall of the booster pump base, an inserting column is disposed on an upper portion of the booster pump, the top of the inserting column is provided with a booster pump opening, a clamping block II is disposed on a side surface of the inserting column, the inserting column is inserted into the booster pump base from an opening at the bottom of the connection sleeve I, the water passing hole is located in a center of the top of the booster pump base, and the booster pump opening is opposite to the water passing hole and is fixed onto the connection sleeve I through matching between the clamping block II and the clamping groove II.

Further, an inner diameter of the glass ball is greater than an inner diameter of a closing opening at a joint between the suction pipe column and the connection sleeve I.

Further, the housing is clamped to an outer wall of the pump body, the bottle body is clamped to an inner wall of the pump body, and the bottom of the housing abuts against the top of the bottle body.

Compared with the prior art, advantages of the present invention lie in that: the booster pump is separated from the pump body as an independent assembly, and a user may select a sprinkling can with or without the booster pump according to an actual demand, thereby reducing production costs and avoiding superfluous functions. Compared with an original sealing gasket, the glass ball is more convenient in installation and is stable in structure, and the pump cavity has a good sealing property and is not prone to leakage.

### BRIEF DESCRIPTION OF DRAWINGS

Drawings forming a part of the present invention are used for providing further understanding of the present invention, and schematic embodiments of the present invention and description thereof are used for explaining the present invention and do not constitute undue restrictions on the present invention. In the drawings:

FIG. 1 is a schematic structural diagram of a sprinkling can according to the present invention;

FIG. 2 is a schematic structural diagram of a pump body according to the present invention;

FIG. 3 is a bottom view of a pump body according to the present invention;

FIG. 4 is a schematic structural diagram of a suction assembly according to the present invention; and

FIG. 5 is a schematic structural diagram of a connection sleeve II according to the present invention.

Reference numerals in the drawings: 1. housing 1; 2: trigger 2; 3. piston 3; 4. spring 4; 5. spray head 5; 6. pump body 6; 7. glass ball 7; 8. connection sleeve I 8; 9. suction assembly 9; 10. bottle body 10; 11. trigger base 11; 12. water inlet hole 12; 13. pump cavity 13; 14. water outlet hole 14; 15. water outlet channel 15; 16. spray head base 16; 17. air inlet channel 17; 18. air outlet hole 18; 19. clamping groove 119; 20. booster column 20; 21. water inlet column 21; 22. air outlet column; 23. suction pipe column; 24. air inlet column; 25. water passing hole; 26. booster pump base; 27. clamping groove II; 28. clamping block I; 29. booster pump opening; 30. inserting column; 31. clamping block II; 32. booster pump; 33. suction pipe; 34. connection sleeve II; 35. closing opening.

### DETAILED DESCRIPTION OF THE EMBODIMENTS

The present invention is described in detail in the following with reference to the accompanying drawings and in conjunction with embodiments. It should be noted that, without conflict, the embodiments of the present application and the features in the embodiments can be combined with each other.

In the description of the present invention, it should be understood that, the orientations or positional relationships indicated by the terms “center”, “up”, “down”, “left”, “right”, “vertical”, “horizontal”, “inner”, “outer”, “bottom”, “top”, etc. are based on those shown in the accompanying drawings, intended only for the convenience of describing the present invention and for simplifying the description, and not intended to indicate or imply that the referred device or element must be provided with a particular orientation or constructed and operated with a particular orientation, therefore not allowed to be construed as a limitation of the present invention.

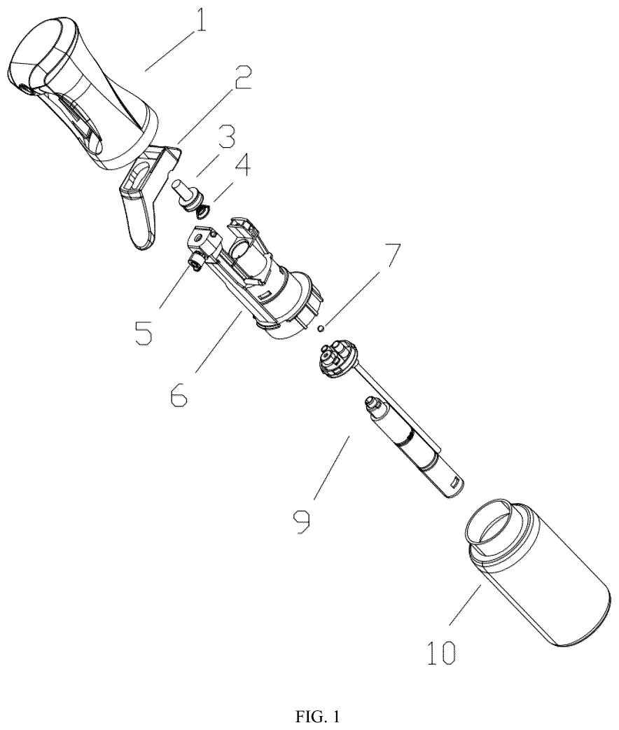

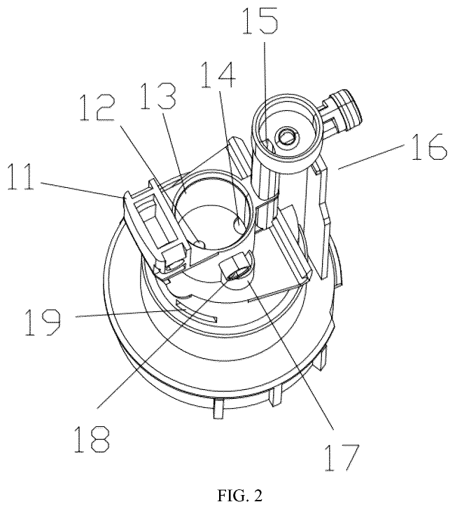

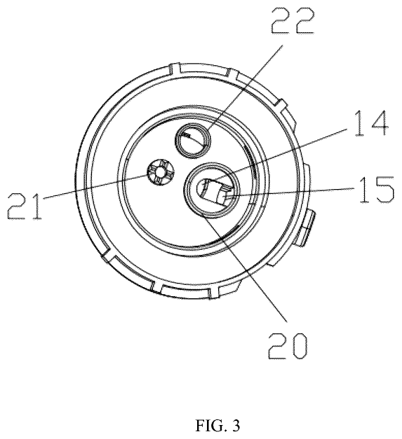

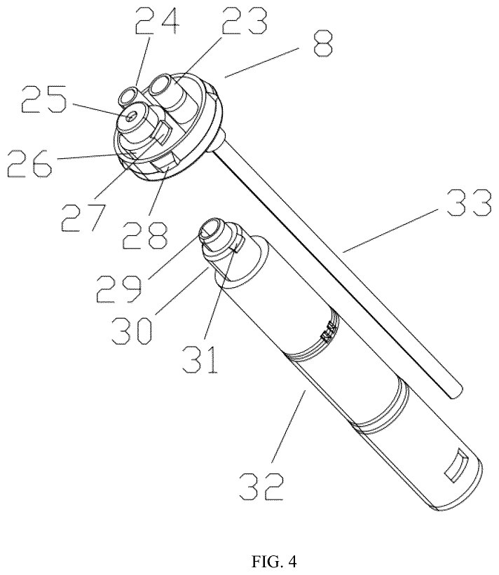

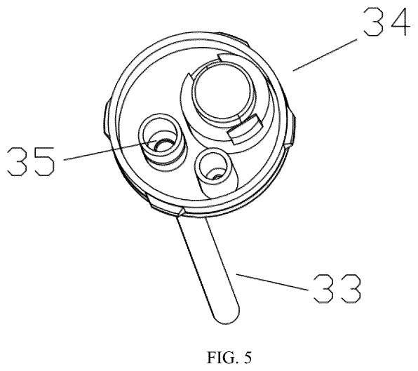

Referring to FIG. 1, FIG. 2, FIG. 3, FIG. 4, and FIG. 5, a sprinkling can provided by the embodiments includes: a spray head 5, a trigger 2, a pump body 6, a suction assembly 9, a housing 1, and a bottle body 10. The spray head 5 and the trigger 2 are fixed on an outer side of the pump body 6, the pump body 6 is provided with a water inlet and outlet facility and a ventilation facility, the top of the pump body 6 is provided with a pump cavity 13, an elastic device is disposed in the pump cavity 13, the bottom of the pump body 6 is clamped with the top of the suction assembly 9, the suction assembly 9 is composed of a connection sleeve I 8, a suction pipe 33, and a booster pump 32, the connection sleeve I 8 is provided with a suction pipe column 23, an air inlet column 24, and a booster pump base 26, the air inlet column 24 and the suction pipe column 23 are internally hollow, a glass ball 7 is disposed in the suction pipe column 23, the suction pipe 33 is inserted into the bottom of the suction pipe column, the booster pump base 26 is provided with a water passing hole 25, the bottom of the booster pump base 26 is clamped with the top of the booster pump 32, the connection sleeve I 8 can be replaced with a connection sleeve II 34, and the connection sleeve II 34 differs from the connection sleeve I 8 in that the booster pump base 26 has no water passing hole 25.

A spray head base 16 and a trigger base 11 are disposed on two sides of the pump cavity 13, the spray head 5 and the trigger 2 are fixed on the spray head base 16 and the trigger base 11 respectively, a piston 3 and a spring 4 are disposed in the pump cavity 13, the top of the piston 3 abuts against the trigger 2, and the bottom of the piston abuts against the spring 4.

A water outlet channel 15 is disposed in the spray head base 16, the bottom of the pump cavity 13 is provided with a water inlet hole 12 and a water outlet hole 14, outer sides of the water outlet hole 14 and the water outlet channel 15 extend downwards to form a booster column 20, the water outlet hole 14 communicates with the water outlet channel 15 of the spray head base 16, the water inlet hole 12 extends downwards to form a water inlet column 21, a side wall of the pump cavity 13 is provided with an air outlet hole 18, an air inlet channel 17 is disposed below an outer side of the air outlet hole 18, the air inlet channel 17 extends downwards to form an air outlet column 22, the top of the booster pump base 26 is in inserted connection with the booster column 20, the water inlet column 21 is in inserted connection with the suction pipe column 23, and the air inlet column 24 is in inserted connection with the air outlet column 22.

A clamping groove 119 is disposed on a side wall of the pump body 6, a clamping block I 28 is disposed on a side wall of the connection sleeve I 8, and the suction assembly 9 is fixed in the pump body 6 through matching between the clamping block I 28 and the clamping groove 119.

A clamping groove II 27 is disposed on a side wall of the booster pump base 26, an inserting column 30 is disposed on an upper portion of the booster pump 32, the top of the inserting column 30 is provided with a booster pump opening 29, a clamping block II 31 is disposed on a side surface of the inserting column 30, the inserting column 30 is inserted into the booster pump base 26 from an opening at the bottom of the connection sleeve I 8, the water passing hole 25 is located in a center of the top of the booster pump base 26, and the booster pump opening 29 is opposite to the water passing hole 25 and is fixed onto the connection sleeve I 8 through matching between the clamping block II 31 and the clamping groove II 27.

An inner diameter of the glass ball 7 is greater than an inner diameter of a closing opening 35 at a joint between the suction pipe column 23 and the connection sleeve I 8.

The housing 1 is clamped to an outer wall of the pump body 6, the bottle body 10 is clamped to an inner wall of the pump body 6, and the bottom of the housing 1 abuts against the top of the bottle body 10.

During use of the sprinkling can of the embodiments, when the trigger is pulled, the trigger squeezes the piston downwards, the spring shrinks, air in the pump cavity is discharged through the air outlet hole, and the glass ball seals a through hole of the connection sleeve; and when the trigger is released, air pressure in the bottle body is less than external air pressure, liquid in a bottle enters the pump cavity through the suction pipe, the glass ball is ejected away, and the liquid in the pump cavity is sprayed out from the spray head directly after passing through the water outlet hole and the water outlet channel. When a user has no demand for injection pressure, the connection sleeve I in the suction assembly can be detached and replaced with the connection sleeve II.

The above descriptions are only preferred embodiments of the present invention and are not used to limit the present invention. For those skilled in the art, the present invention may have various modifications and changes. Any modification, equivalent replacement, improvement, etc. made within the spirit and principles of the present invention shall be in FIG. 5

What is claimed is:

1. A sprinkling can, comprising: a spray head, a trigger, a pump body, a suction assembly, a housing, and a bottle body, wherein the spray head and the trigger are fixed on an outer side of the pump body, the pump body is provided with a water inlet and outlet facility and a ventilation facility, a top of the pump body is provided with a pump cavity, and an elastic device is disposed in the pump cavity, wherein a bottom of the pump body is clamped with a top of the suction assembly, the suction assembly is composed of a connection sleeve I, a suction pipe, and a booster pump, the connection sleeve I is provided with a suction pipe column, an air inlet column, and a booster pump base, the air inlet column and the suction pipe column are internally hollow, a glass ball is disposed in the suction pipe column, the suction pipe is inserted into a bottom of the suction pipe column, the booster pump base is provided with a water passing hole, a bottom of the booster pump base is clamped with a top of the booster pump, the connection sleeve I can be replaced with a connection sleeve II, and the connection sleeve II differs from the connection sleeve I in that the booster pump base has no water passing hole.

2. The sprinkling can according to claim 1, wherein a spray head base and a trigger base are disposed on two sides of the pump cavity, the spray head and the trigger are fixed on the spray head base and the trigger base respectively, a piston and a spring are disposed in the pump cavity, a top of the piston abuts against the trigger, and a bottom of the piston abuts against the spring.

3. The sprinkling can according to claim 2, wherein a water outlet channel is disposed in the spray head base, a bottom of the pump cavity is provided with a water inlet hole and a water outlet hole, outer sides of the water outlet hole and the water outlet channel extend downwards to form a booster column, the water outlet hole communicates with the water outlet channel of the spray head base, the water inlet hole extends downwards to form a water inlet column, a side wall of the pump cavity is provided with an air outlet hole, an air inlet channel is disposed below an outer side of the air outlet hole, the air inlet channel extends downwards to form an air outlet column, the top of the booster pump base is in inserted connection with the booster column, the water inlet column is in inserted connection with the suction pipe column, and the air inlet column is in inserted connection with the air outlet column.

4. The sprinkling can according to claim 1, wherein a clamping groove I is disposed on a side wall of the pump body, a clamping block I is disposed on a side wall of the connection sleeve I, and the suction assembly is fixed in the pump body through matching between the clamping block I and the clamping groove I.

5. The sprinkling can according to claim 1, wherein a clamping groove II is disposed on a side wall of the booster pump base, an inserting column is disposed on an upper portion of the booster pump, a top of the inserting column is provided with a booster pump opening, a clamping block II is disposed on a side surface of the inserting column, the inserting column is inserted into the booster pump base from an opening at a bottom of the connection sleeve I, the water passing hole is located in a center of a top of the booster pump base, and the booster pump opening is opposite to the water passing hole and is fixed onto the connection sleeve I through matching between the clamping block II and the clamping groove II.

6. The sprinkling can according to claim 1, wherein an inner diameter of the glass ball is greater than an inner diameter of a closing opening at a joint between the suction pipe column and the connection sleeve I.

7. The sprinkling can according to claim 1, wherein the housing is clamped to an outer wall of the pump body, the bottle body is clamped to an inner wall of the pump body, and a bottom of the housing abuts against a top of the bottle body.
